(19) United States
(12) Patent Application Publication
(10) Pub. No.: US 2018/0050636 A1
(43) Pub. Date: Feb. 22, 2018

(54) VIRTUAL PANORAMIC ROOF OR SUNROOF ASSEMBLY

(71) Applicant: SEs Solutions GmbH, Freital (DE)

(72) Inventor: Serle ESPIG, Hamburg (DE)

(21) Appl. No.: 15/783,681

(22) Filed: Oct. 13, 2017

Related U.S. Application Data
(63) Continuation of application No. PCT/EP2016/058122, filed on Apr. 13, 2016.

(30) Foreign Application Priority Data
Apr. 13, 2015 (DE) 102015105612.7

(51) Int. Cl. B60R 1/00

(52) U.S. Cl. CPC B60R 1/00; B60R 2300/80; B60R 2300/60; B60R 2300/202

(57) ABSTRACT

A virtual panoramic roof or sunroof for a motor vehicle (100), the roof being capable of realistically reproducing or adapting the outside world. The roof offers many advantages, such as a reduction in driving noise and a decrease in fuel consumption of the motor vehicle (100) compared to conventional sunroofs. The assembly comprises at least one sensor device (102), in particular an image-capture device for recording the surroundings of the motor vehicle (100), and at least one reproduction device, disposed on an inner face of the roof (101), for reproducing a virtual representation of the surroundings captured by the sensor device.

### TECHNICAL FIELD OF THE INVENTION

The invention relates to an assembly for a roof of a motor vehicle.

### PRIOR ART

Known panoramic roofs or sunroofs for motor vehicles are adapted to open the roof of the vehicle, to impart a freer, less constricted feeling in the vehicle, to perceive the surroundings in their entirety and/or to “fill up” on sun. As a result of the widespread use of air-conditioning system, increasingly less use is being made of opening the sunroof and some panoramic roofs can only be tilted slightly or can no longer be opened. With the use of a panoramic roof or sunroof, the risk of sunburn and therefore the risk of cancer, increases, pollen, fine dust and ozone can additionally have a negative influence on the respiratory tracts, the airflow can cause colds, and noise can negatively influence the attentiveness.

Panoramic roofs or sunroofs are frequently offered by the vehicle manufacturers as special equipment and are installed ex-works. As optional special equipment, the multiplicity of body variants and therefore the complexity in the assembly process, i.e. the manufacturing expenditure, is thereby increased for the vehicle manufacturer. In the event of an accident in which the vehicle rolls over, the sunroof can be disadvantageous. As a result of the installation under the vehicle roof, in the case of many sunroofs headroom is lost in many places—in some cases more than 5 cm. Sunroofs can additionally become leaky with time and—in particular in the open state—they increase the wind resistance and therefore the fuel consumption and the driving noise. In addition, they cause a deterioration in the driving dynamics since additional weight on the roof negatively influences the centre of gravity or the cornering power, also the permitted roof load is partially reduced. As soon as a roof box is mounted, a panoramic roof or sunroof is at least almost completely darkened.

Known from the document DE 10 2011 051 891 A1 is an integrable foldable roof box made of lightweight construction materials which completely or largely covers the roof surface and remains or can remain on the vehicle roof at all times. A disadvantage here is that a combination of an integrable foldable roof box with sunroof is certainly technically possible but is very complex to implement and many of the aforesaid disadvantages of a sunroof have not been eliminated.

### DESCRIPTION OF THE INVENTION

### Object, Solution, Advantages

The object of the invention is to provide a roof for a vehicle which imparts a user of the vehicle a less constricted feeling in the vehicle and allows him to perceive the surroundings in their entirety without having the previously described disadvantages and without this perception being obscured by a roof box.

This object is solved by an assembly for a roof of a motor vehicle, comprising at least one sensor device, in particular an image-capture device for recording the surroundings of the motor vehicle, in particular for the pictorial recording of these surroundings, as well as at least one reproduction device, in particular image reproduction device, which is disposed on an inner face of the roof, in particular in a position of a sunroof and/or panoramic roof, for reproducing a virtual representation, in particular a virtual pictorial representation, of at least the surroundings captured by the at least one sensor device at least approximately equal to a perception, in particular view, of at least the surroundings through such a sunroof and/or panoramic roof.

Advantageously, in addition optionally the at least one sensor device, in particular image-capture device, can be additionally adapted to record at least a subregion of an interior adapted for the location of at least one user, in particular for the pictorial capture of at least this subregion of this interior. The at least one reproduction device can optionally additionally extend over the inner face of the roof, preferably over further inner faces of the interior. Particularly preferably the at least one reproduction device extends over a subregion of an inner face of the windscreen. Further optionally the at least one reproduction device extends over a subregion of an outer face of the motor vehicle, in particular the windscreen. Thus, optionally in addition, for example a virtual representation, in particular a virtual pictorial representation of the surroundings captured by the at least one sensor device, can also be reproduced on the inner face or the subregion of the inner face of the windscreen or a virtual representation, in particular a virtual pictorial representation, of the interior captured by the at least one sensor device or a subregion thereof can be reproduced on the inner face or the subregion of the inner face of the windscreen and/or on the outer face or the subregion of the outer face of the windscreen.

At this point, it should be mentioned that a proposal made by the manufacturers Toyota and the Copenhagen Institute of Interaction Design, to fit a motor vehicle with windows and a panoramic sunroof with so-called “augmented reality” can be deduced from the internet presence http://www.cnet.com/news/toyota-develops-augmented-reality-windows-sunroof/, entry read on 10.04.2015 at 12:09. Such a window should enable a passenger to draw, sketch, scribble, bring a scene section close, translate characteristics of the scenes passing by into the local language and estimate distances from terrain objects on a surface of the window, i.e. the window pane. Such a sunroof should display information on the sky as well as virtual images of stars, presumably at night.

In the broadest manifestation the assembly according to the invention is formed by a combination of sensors, devices and applications to form a panoramic roof or sunroof for motor vehicles which represents virtually the outside world, i.e. the surroundings of the motor vehicle and at the same time is not or only partially air-permeable, and transparent, i.e. is at least largely air-impermeable and optically opaque. Advantageously the assembly according to the invention is configured with a virtual panoramic roof or sunroof which captures and reproduces the external surroundings in their entirety or partially.

In the virtual panoramic roof, sensors on the roof of the motor vehicle or on a roof box of the motor vehicle, preferably on the lid of the roof box of the motor vehicle, capture the surroundings and transmit these recordings, in particular images and other sensor data or information via terminals, aids and/or applications into the vehicle interior in order to impart to a user, i.e. a vehicle occupant or passenger, a free, i.e. in particular unrestricted, feeling in the vehicle, to enable him to perceive the surroundings in their entirety and afford him many other possibilities. Sensors such as, for example, cameras of designs known per se allow a very flexibly adaptable, versatile design of the assembly according to the invention as a result of miniaturization and integrability in materials, e.g. fibre composite materials. Further known are light, high-resolution image reproduction devices, i.e. monitors, in the form of millimetre-thin films which can be favourably produced on a large scale. Thus, three-dimensional image contents can also be displayed in high resolution.

Beyond the function to process video signals and project into the vehicle interior, the assembly according to the invention also serves to allow the user a complete perception of the outside world and/or adapt the outside world to his needs. Preferably the assembly according to the invention can be connected to a vehicle on-board computer. By installing or connecting to further terminals, it is possible if required to realistically reproduce and modify the outside world by means of a pure image reproduction. Preferably, for example, external noise can be reproduced in the vehicle interior with external microphones via a vehicle loudspeaker system, also designated as vehicle sound system. Wind can be determined via pressure sensors and supplied unfiltered or filtered of odours, pollen, fine dust and ozone via ventings on the vehicle roof, e.g. guided into the hair. The air channels can be supplied with air and/or controlled via an air-conditioning system or a so-called automatic air-conditioning of the motor vehicle. Preferably in particular in an automobile the air can be supplied via an A and/or B pillar. Further preferably light and/or heat sensors can be provided which are adapted for example for determining light intensities in the surroundings, in particular infrared values, and can be controlled by the infrared lamps preferably arranged on the vehicle roof for delivering infrared light. Further advantageously odour sensors can be provided for determining popular scents and scent dispensers, preferably natural scent dispensers, can be provided for reproducing or admixing these scents. At the same time, the virtual panoramic roof can be adapted to the wishes of the user whereby the user can adapt an internal wind strength in the passenger compartment of the motor vehicle as desired, regulate tanning stages, switch odours on and off, lighten or darken the sky, amplify desired noises such as bird song, and dampen or fade out undesired noises, e.g. road noise. Also completely different representations of the outside noise can be provided, e.g. sunshine or a starry sky on a cloudy day. In a preferred further development of the invention, electrical energy for these representations can be produced by solar cells which are preferably disposed on the roof of the motor vehicle or a lid of an integrable or integrated roof box on the roof of the motor vehicle.

In the same way as the invention makes it possible for the user inside the motor vehicle to perceive the outside world of the motor vehicle via the virtual panoramic roof, according to a preferred further development of the assembly according to the invention it is also provided to conversely make the user perceptible for the outside world of the motor vehicle. In particular loudspeakers but also image reproduction devices on an outside of the vehicle or on a roof box of the aforesaid type can relay recorded sounds or images from the vehicle interior to the outside world as required.

Advantageous embodiments of the invention are characterized in the subclaims.

A preferred further development of the assembly according to the invention is characterized in that the virtual representation, in particular the virtual pictorial representation, of the surroundings captured by the at least one sensor device can be adapted to the needs of a user, in particular that to this end the at least one sensor device, in particular image-capture device and/or the at least one reproduction device, in particular image reproduction device, is/are configured to be adjustable, in particular adjustable by the user. Preferably the virtual panoramic roof or sunroof according to the invention is characterized in that the virtual surroundings can be adapted to the needs of the user.

A preferred further development of the assembly according to the invention is characterized in that the roof is configured with a roof box, in particular a foldable and/or integrable roof box, and that at least one of the at least one sensor devices is disposed on the roof box, in particular in, at and/or on a lid of the roof box.

A preferred further development of the assembly according to the invention is characterized in that at least one reproduction device, in particular image reproduction device, is arranged to extend at least on a roof liner forming the inner face of the roof at least approximately along the entire roof liner, in particular at least approximately as far as the windscreen, i.e. front window, of the motor vehicle and/or at least over a subregion of at least the windscreen. The virtual panoramic roof or sunroof thus preferably extends at least as far as the windscreen and covers the entire roof liner or large parts thereof. Particularly preferably, the virtual panoramic roof or sunroof, i.e. the reproduction device, in particular image reproduction device forming this, extends further over at least a subregion, in particular an upper subregion, of at least the windscreen, advantageously however also at least over subregions of side and/or rear windows.

A preferred further development of the assembly according to the invention is characterized in that at least an upper region of at least the windscreen on its inner and/or outer face with at least one reproduction device, in particular image reproduction device, is configured to
optionally reproduce a virtual representation of at least one section of the surroundings, in particular of a front and/or rearward surroundings, preferably towards the interior of the motor vehicle, and/or
optionally reproduce a virtual representation of at least one subregion of the interior, in particular of a driver of the motor vehicle, towards the interior and/or towards the surroundings of the motor vehicle and/or
optionally reproduce at least one virtual representation of at least one item of information, in particular of a vehicle display instrument, preferably of a navigation display or at least one vehicle operating state, preferably towards the interior of the motor vehicle and/or
optionally reproduce at least one virtual representation of at least one item of information preferably towards the surroundings of the motor vehicle, in particular for the representation, of a vignette, a driving school, taxi, parking permit, pollution badge and/or advertising display,
optionally at least partially dimming a transparency of the at least one upper region of at least the windscreen to form a light screen, in particular sunscreen,
   wherein for controlling the preceding reproductions, at least one sensor signal of at least one sensor, in particular
of at least one sensor for recording a direction of incidence of the sunlight and/or
at least one sensor for recording a movement and/or gesture and/or viewing direction of at least one user of the motor vehicle, in particular of the driver,
   is used in particular at least in the manner
that the at least partial dimming of the transparency of the at least upper region of at least the windscreen is undertaken to form the light screen, in particular sun visor, depending on the direction of incidence of the sunlight and/or
that the optional reproduction of the virtual representation of the at least one section of the surroundings, in particular of the front and/or rearward surroundings, and/or of the at least one subregion of the interior, preferably towards the interior of the motor vehicle, is undertaken depending on the movement and/or gesture and/or viewing direction of the at least one user of the motor vehicle, in particular of the driver.

Preferably the windscreen but also at least one other window pane of the motor vehicle can thus advantageously be configured with a combination of a sun visor with flexibly usable reproduction device, in particular image reproduction device. The relevant window pane, in particular windscreen is in this case configured as a transparent reproduction device, in particular image reproduction device, which can be controlled as required into an opaque operating state, e.g. in a configuration as an LCD display or the like. In this case, continuous shadings are possible as with sunglasses. The reproduction device, in particular image reproduction device, can advantageously be used for displaying various vehicle displays such as instruments, navigation screen and the like, in particular in the manner of a windscreen projector (so-called “head-up display”). In addition, in particular in the driver-side area of the windscreen, an image delivered by a reversing camera or a comparable sensor can be faded in so that this region of the reproduction device, in particular image reproduction device, which goes spatially beyond the extension of a sunroof and/or panoramic roof in the conventional sense can be used as a virtual rear mirror. The extension of the image of the reversing camera, i.e. image section and/or image size of the view shown by the virtual rear mirror can be adjustable. Preferably image section and/or image size are controllable via sensors which record a movement and/or gesture, preferably a head movement, head position or viewing direction of the eyes. Thus, the rear mirror view can be activated for example when the driver turns his head or looks in a direction which is interpreted as a view into a—real—rear mirror or the reproduction surface for the rear mirror view can be controlled—in particular enlarged, particularly preferably to give a view extending at least substantially continuously over the width of the windscreen, i.e. when the driver looks and/or turns his head in a direction in which the rear mirror is conventionally found, on the reproduction device, in particular image reproduction device, the rear mirror view is faded into a continuous and/or large area image strip. As soon as the driver “looks in the rear mirror”, the mirror, i.e. the reproduced rear mirror view, becomes larger. A panoramic view in particular of the rearward surroundings of the motor vehicle is then possible with the result that an effective monitoring of blind spots can be achieved.

In particular the windscreen particularly when the sun visor function is activated, i.e. during shading or darkening, can also be used to reproduce virtual representations even of the front surroundings of the motor vehicle, e.g. traffic light displays can be recorded and faded in which the driver can usually only identify with difficulty when conventional sun visors are folded down.

The sun visor function can also be controlled automatically, apart from by at least one of the users of the motor vehicle, preferably by light sensors which detect at least one direction of incidence of the light, in particular the solar radiation and/or a light intensity and accordingly control the sun visor function, i.e. the intensity of the light damping and spatial extension of those regions at least of the windscreen which are to be shaded or darkened. In the case of deep solar radiation, the virtual sun roof is thus extended at least to upper regions of at least the windscreen. This is also possible as required for side and/or rear windows. If no solar radiation is presented, the panes become transparent again in the conventional manner.

In particular, the region of the reproduction device, in particular image reproduction device extending onto the windscreen can also be fitted with a sensor, in particular image recorder, for recording an image of a front-seat passenger and reproducing it on the windscreen. Such an image can also be reproduced when the shading of the windscreen is not activated, e.g. against a flat delimited dark background. Corresponding devices are also possible for the other users of the motor vehicle.

Preferably in the area of the windscreen but also extending over other windows of the motor vehicle, further displays can be presented both on inner faces and on outer faces of the windows. In particular, an internal view of the motor vehicle, preferably of the driver, particularly preferably of the face of the driver, can be shown on a region of the outer face of the windscreen and conversely at the same time an image of the front surroundings of the motor vehicle or an image section of these front surroundings can be reproduced on a region of the inner face of the windscreen. In this way, even with an active sun visor function, i.e. shaded or darkened windscreen, it is in particular possible to make eye contact between in particular the driver of the motor vehicle and other road users.

In particular, the outer faces, preferably the outer face of the windscreen, can be used to reproduce multiple further displays and representations. For example, vignettes, emission or pollution badges, driving school identifications, taxi signs, parking tickets or parking disks, advertising or comparable information such as a for-sale notice for the vehicle, company labels etc., an identification for a passenger service or personalized information of any kind can be virtually reproduced. These displays can preferably be controlled via a mobile data unit, e.g. a mobile telephone if, for example a parking ticket is booked or a ride share is organized. With regard to an application for an offer of a ride share or here a transport opportunity for transported goods, reference is expressly made to the international patent application with the publication number WO 2014/147082. When generalized, the most diverse information available in the motor vehicle can thus be utilized for third parties, i.e. persons in the surroundings. Advantageously this applies to information relating to surroundings above the motor vehicle, e.g. relating to processes in the sky such as weather conditions but also structures such as bridges, tunnels etc.

As will be described hereinafter, in the interior of the motor vehicle, the reproduction device, in particular image reproduction device can also be configured in the region extending onto the windscreen with a touch screen function by means of which most diverse functions can be controlled by the users. Such a touch screen function can extend over the entire extent of the virtual panoramic roof and/or sunroof so that the most diverse operating process are possible from any place of any of the users, i.e. even from rear seats in the motor vehicle.

The most diverse displays of the reproduction device, in particular image reproduction device, can be configured in most diverse representation according to content and purpose, e.g. photorealistic, symbolic such as for example by so-called “icons” or in another way.

A preferred further development of the assembly according to the invention is characterized in that the at least one reproduction device, in particular image reproduction device, is configured at least partially with a touch screen, preferably that the reproduction of the virtual representation of the surroundings, can be controlled via this touch screen, further particularly preferably further devices of the motor vehicle, in particular devices of an interior of the motor vehicle, particularly advantageously spotlights, reading lamps and/or sun visors, can be controlled and/or can be operated and/or can be adjusted. A touch screen function—so-called “touch screen function”—is advantageously integrated in the image reproduction device preferably configured with a monitor and/or a display via which inter alia the spotlights, reading lamps and sun visors can be operated.

Therefore, beyond a single element or a simple combination of a monitor on the roof liner with a processing unit, the concept of the virtual panoramic roof or sunroof is a combination of a plurality of sensors and terminals for an entire representation of the outside world which can be detected with all the human senses. Accordingly, the virtual panoramic roof or sunroof has a plurality of components which interact. The virtual panoramic roof or sunroof can extend over the entire vehicle roof as far as the windscreen and encompass these at least partially and advantageously also side and/or rear windows, as explained hereinbefore. The usual spotlights/reading lamps and sun visors can then be operated via a so-called touch screen function in the monitor or display. Instead of fold-down sun visors, optionally movable sun visors or the previously described sun visor function of the windscreen can be used.

A preferred further development of the assembly according to the invention is characterized in that the at least one reproduction device, in particular image reproduction device, comprises at least two partial reproduction devices of which at least one front one is disposed at least predominantly in a front region of the roof and at least one rear one is disposed at least predominantly in a rear region of the roof and that preferably a spatial position of at least one of the partial reproduction devices, preferably of the at least one rear partial reproduction device is adjustable and/or controllable, in particular that the at least one rear partial reproduction device is configured to be foldable and/or rotatable, particularly preferably capable of being folded down. In this preferred embodiment of the invention, the monitor designated as visual component of the virtual sunroof is divided. The rear part or at least one of the rear parts, but optionally at least one of the front parts can be folded down so that the passengers in the rear seat and optionally also the front, in particular on the passenger seat, can look onto a large surface, e.g. films or play computer games instead of looking out of the sunroof. If the partial reproduction devices, in particular foldable reproduction devices, are configured as touch screens, drawings—e.g. as a diversion for child passengers—can advantageously be prepared; e.g. it is possible to paint on the roof liner, possibly combined with the pictorial representation of the surroundings. In particular but not exclusively, in a motor vehicle adapted for so-called independent driving, i.e. a motor vehicle with an automatic drive control, in particular a lane control and/or distance control and/or speed control and/or route control, which enable a driverless driving of the motor vehicle, this option is also of interest for passengers in the front region, i.e. optionally also the at least one partial reproduction device can be configured to be foldable and/or rotatable, particularly preferably capable of being folded down, but this configuration of the at least one front partial reproduction device can also be provided in a conventionally controlled motor vehicle at least for at least one passenger seat, furthermore it can also be provided as equipment of a driver's seat of the motor vehicle and there in particular can be used when the motor vehicle is at a standstill.

Instead of the previously described reproduction device, in particular image reproduction device, in the form of a screen or parallel to this, the reproduction device can optionally also be configured with a hologram-generating device. It is therefore possible for a user to view an image to be reproduced from different views. Also each user could separately adjust the image to be reproduced according to his wishes. Furthermore, preferably on the basis of a hologram representation—each user can reproduce the represented image in an individual lighting for him; e.g. more in a red shade or a blue shade, lighter or darker and thus adapt the representation to his respective wishes or moods.

An assembly for a roof of a motor vehicle with a roof box, in particular a foldable and/or integrable roof box, which has a base element or a trough element, i.e. a trough-like base element, is characterized in that the base element or trough element has at least one recess between transverse pillars of the roof.

A preferred further development of the preceding assembly according to the invention for a roof of a motor vehicle with a roof box having a base element or a trough element is characterized in that the base element or trough element is configured with at least one damping element, in particular at least one damping mat (21), which forms both a sound protection and a damping for items to be stored in the roof box, wherein preferably the at least one damping element, in particular the at least one damping mat (21), is disposed in the at least one recess. The base element or trough element of the roof box, in particular the foldable and/or integrable roof box, i.e. vehicle roof box, therefore has one or more damping mats which serve both as sound protection and as damping for items in the roof box.

Another embodiment of the assembly according to the invention for a roof of a motor vehicle with a roof box is characterized in that the at least one reproduction device, in particular image reproduction device, is disposed on the inner face of the roof, in particular in the position of the sunroof and/or panoramic roof, at least partially in the region underneath the at least one recess of the base element or trough element.

As a result of the light millimetre-thin monitors, weight can be saved on the vehicle or vehicle roof and new space can be recovered under the roof. This space can be used in another way, e.g. for a recessed base element of a foldable roof box of the previously described type. The sound damping which is usually attached to the roof liner can then be attached differently and thus take on addition functions. Instead, in a further development of the invention, instead of being attached to the roof liner, the damping is at least partially inserted in the base or trough element of the integrated and/or foldable roof box. As a result, the damping can be used at the same time as sound damping of external noise and as damping and buffer for items stored in the roof box. In addition to the additional function of the damping, this further development of the invention enables savings of weight and space in the vehicle roof. The base element of the integrated and/or foldable roof box is formed so that it has recesses between the transverse pillars of the roof, i.e. in particular the A, B, C pillars and thereby forms one or more troughs. These recesses or troughs can be configured to be deeper in so-called combi vehicles, e.g. in the rear region of the vehicle roof, in particular above a boot than in the front region of the roof, in particular above the passenger compartment, since frequently more unused space exists at the bottom there than in the front region. Items related to the use of the roof box can be mounted in the recesses, e.g. suitable pockets, a folding stool for better accessibility to the roof box, folding boxes for shopping, aids for locking items such as tension straps or ski holders.

The motor vehicle configured according to the invention can be fixedly integrated or retrofittable. Sensors can be provided both in a motor vehicle without a roof box and also in one with a retrofitted or removable roof box as well as with a fixedly integrated roof box on the roof of the motor vehicle. In addition, sensors are arranged on the roof box. If a motor vehicle is fitted with sensors both on the roof box and also on the motor vehicle roof, i.e. in a retrofitted roof box, the roof box can preferably be provided with a transparent base. It is thereby possible to record the contents of the roof box via the sensors on the motor vehicle roof for which barcodes can also be read. For the configuration of the roof box per se reference is expressly made to the international patent application with the publication number WO 2013/011041.

At least one of the sensors on the roof of the motor vehicle, in particular on the roof box, can be configured as a height sensor for detecting a clearance height on a travel section, in particular a clearance height under bridges, in tunnels, under trees, traffic sign bridges or the like. In particular when the vehicle height is increased by a roof box, the driver can be warned by a display, a warning tone or the like and damage to the motor vehicle can be avoided. Advantageously such a height sensor can be integrated in a vehicle radio aerial on the roof, in particular on the roof box.

The invention creates a virtual panoramic roof or sunroof for a motor vehicle which realistically reproduces the outside world or can modify this. It offers many advantages such as for example a reduction of vehicle noise and a reduction of fuel consumption of the motor vehicle compared with conventional sunroofs.

The invention thus enables in an advantageous manner a virtual panoramic roof or sunroof for a motor vehicle, in particular for an automobile with integrated and/or foldable roof box which can be fitted and used in a flexible and versatile manner and affords a considerable increase in driving comfort of the motor vehicle.

### BRIEF DESCRIPTION OF THE DRAWINGS

Exemplary embodiments and preferred embodiments of the invention are shown in the drawings and are described in detail hereinafter with reference to these drawings, wherein further advantageous details can be deduced from the figures and functionally the same, in particular identical elements in all the figures are provided with the same reference numbers and a repeated description of these elements is omitted. In the figures schematically:

FIG. 1 shows a perspective view of the vehicle roof fitted with a plurality of preferably different-type sensors in a front view obliquely from above,

FIG. 2 shows a perspective view of a roof box, in particular of an integrated foldable roof box, configured with a plurality of preferably different-type sensors in a front view obliquely from above,

FIG. 3 shows a perspective view from the vehicle interior with a view of the roof liner with virtual panoramic roof or sunroof from a right side of the vehicle in the direction of travel,

FIG. 4 shows a perspective view from the vehicle interior with a view of the roof liner with virtual panoramic roof or sunroof from a right side of the vehicle in the direction of travel, where the rear part of the monitor is folded down,

FIG. 5 shows a perspective view from the vehicle interior with a view of the roof liner with virtual panoramic roof or sunroof from a right side of the vehicle in the direction of travel, wherein the virtual panoramic roof or sunroof runs as far as the windscreen,

FIG. 6 shows a perspective view of a vehicle body with a base element of a foldable roof box having recesses between the transverse pillars,

FIG. 7 shows a schematic diagram for signal exchange,

FIG. 8 shows a diagram of a roof box with an exemplary embodiment for an attachment of at least one microphone and at least one loudspeaker,

FIG. 9 shows a perspective view of another exemplary embodiment of a vehicle roof fitted with a windscreen which is configured in an upper region adjoining the vehicle roof, preferably on the inner and/or outer face thereof with at least one reproduction device, in particular image reproduction device, in another front view from obliquely above on the outside,

FIG. 10 shows a perspective view of the vehicle interior of the exemplary embodiment according to FIG. 9 with a view in the direction of travel onto the dashboard and the windscreen configured with at least one reproduction device, in particular image reproduction device and

FIG. 11 shows a perspective view of an exemplary embodiment for a roof box fitted with a height sensor according to the invention for a motor vehicle according to one of the preceding exemplary embodiments.

### PREFERRED EMBODIMENT OF THE INVENTION

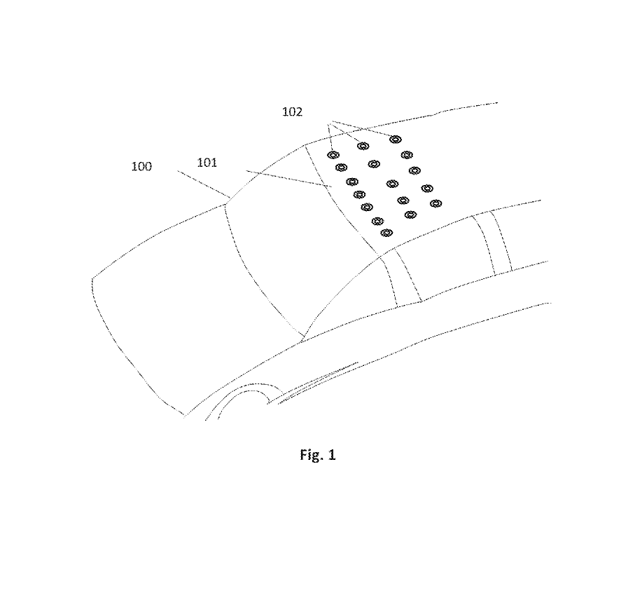

FIG. 1 shows a perspective view of a motor vehicle 100, preferably an automobile, with a vehicle roof 101 which is configured with a plurality of preferably different-type sensors 102. For example here the sensors 102 are arranged in three rows transversely to a longitudinal direction, i.e. direction of travel, of the motor vehicle 100. The sensors 102 are, for example image sensors (i.e. cameras), microphones, temperature sensors and others.

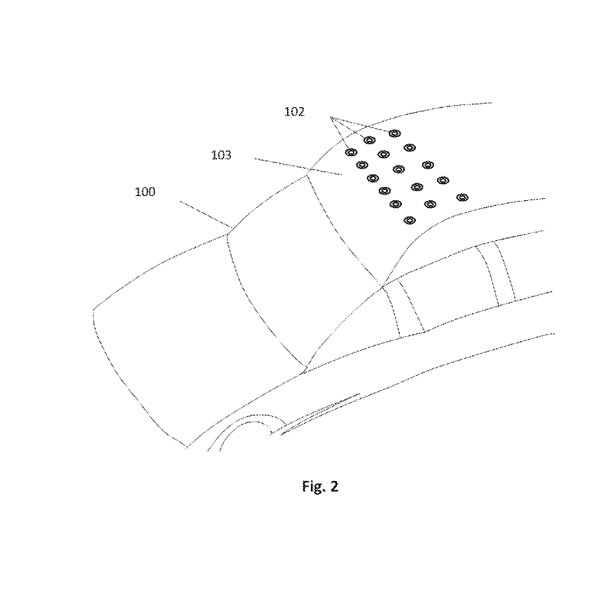

FIG. 2 shows a perspective view of a motor vehicle 100, preferably an automobile having a vehicle roof 101 on which a roof box 103, in particular an integrated foldable roof box 103, is arranged. On the roof box 103, in particular on a lid of the roof box 103, the sensors 102 are arranged in the same manner as in the example according to FIG. 1 on the vehicle roof 101.

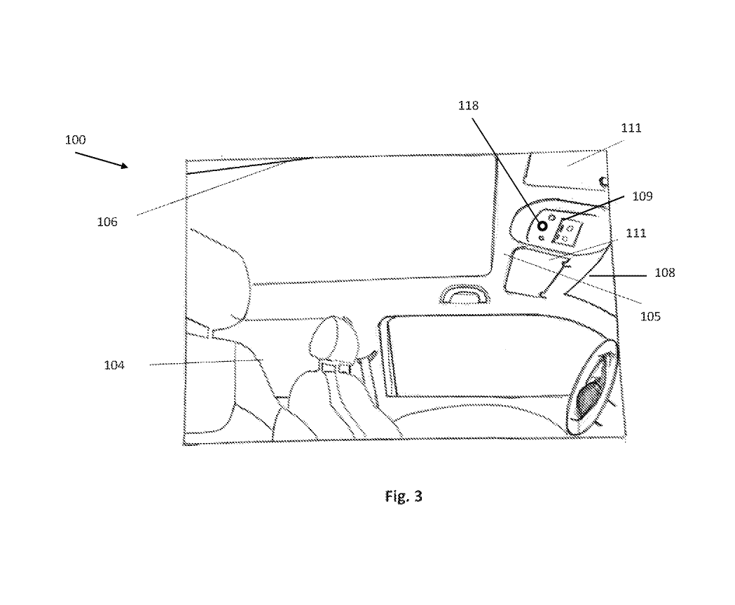

FIG. 3 shows a perspective view of a vehicle interior 104 of the motor vehicle 100 with a view of a roof liner 105 which lines an underside or inner side of the vehicle roof 101. Under the vehicle roof 101, i.e. inserted in the roof liner 105 and at least partially forming the roof liner 105 is a virtual panoramic roof or sunroof 106. The virtual panoramic roof or sunroof 106 in the assembly according to FIG. 3 extends over the front and rear seat of the motor vehicle 100, here an automobile. Here a region of the roof liner 105 which adjoins this in the direction of travel behind a windscreen or front window 108 is excluded from the extension of the virtual panoramic roof or sunroof 106. In this region for example, fold-down sun visors 111 and other operating elements 109 are provided. In addition, a face recognition sensor 118 is arranged for example here. This is used for recognition of the face of at least one of the users of the motor vehicle 100, in particular the driver or a passenger and is preferably for recognizing a tanning of the face, i.e. a complexion of the user, a gesture and/or facial expression e.g. for control of a rear mirror function as described hereinbefore and hereinafter or a position of the eyelids, e.g. for recognition of falling asleep preferably of the driver and for controlling a sleep prevention linked thereto, e.g. wake function and/or drive control, e.g. speed control.

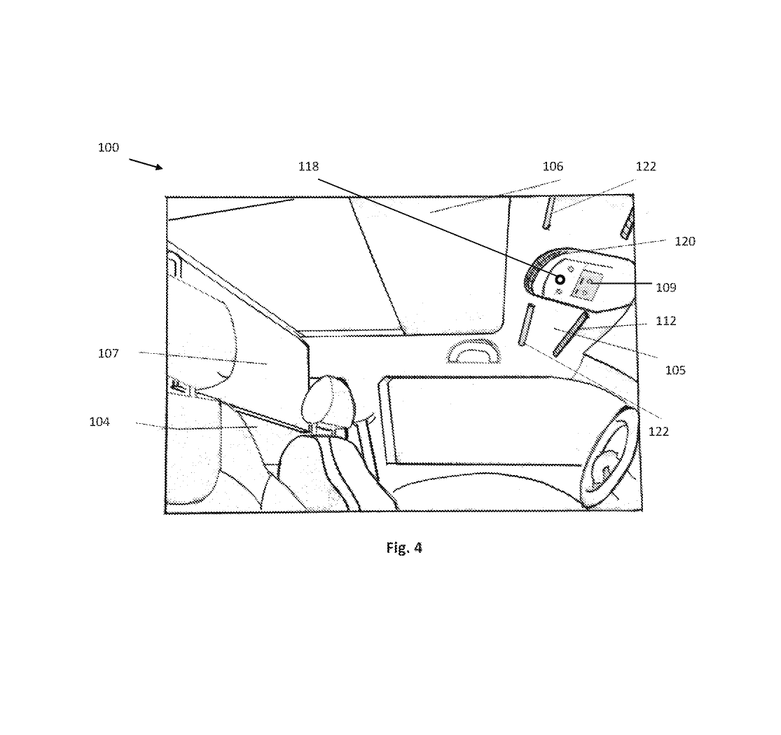

FIG. 4 shows a perspective view of the vehicle interior 104 of the motor vehicle 100 in the same viewing direction as in FIG. 3 from the right side of the motor vehicle 100 in the direction of travel onto the roof liner 105 in a modification of the exemplary embodiment shown in FIG. 3. Therein the virtual panoramic roof or sunroof 106 is divided into a front and a rear part; the rear part 107 of the virtual panoramic roof or sunroof 106 forming a monitor is shown folded down here. In the region of the roof liner 105 which adjoins this in the direction of travel behind the windscreen or front window 108 and which is excluded from the extension of the virtual panoramic roof or sunroof 106, apart from the further operating elements 109, movable sun visors 112 and reading lamps 122 are provided here for example. Advantageously instead of the sun visors 112 indicated here or in addition to these, air outlets 112 are provided through which fresh air can be supplied to the vehicle interior 104 of the motor vehicle 100 and instead of or in addition to the reading lamps 122, tanning lamps 122 can be provided which in particular serve as face tanners for driver and/or passenger and can preferably be controlled by the face recognition sensor 118. In addition, the further operating elements 109 are combined in a console mounted under the roof liner 105 which accommodates loudspeakers 120 of a so-called vehicle sound system.

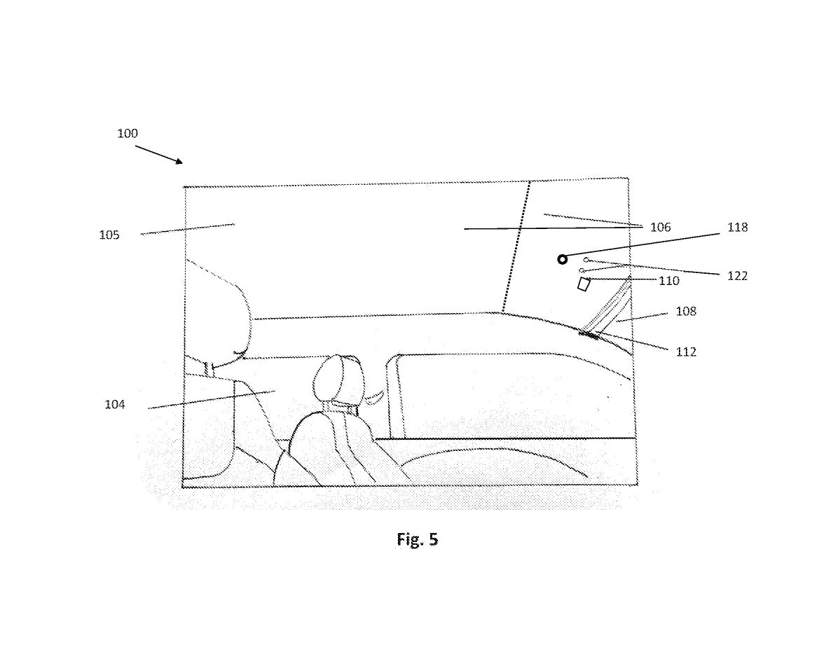

FIG. 5 shows a perspective view of the vehicle interior 104 of the motor vehicle 100 in the same viewing direction as in FIG. 3 from the right side of the motor vehicle 100 in the direction of travel onto the roof liner 105 in a modification of the exemplary embodiment shown in FIG. 3. Therein the virtual panoramic roof or sunroof 106 extends from behind as far as the windscreen 108, i.e. also beyond the region of the roof liner 105 designated in FIGS. 3 and 4, which adjoins this in the direction of travel behind the windscreen or front window 108. In this region which can be reached easily in particular by vehicle passengers on the front seats, preferably a driver of the motor vehicle 100, the virtual panoramic roof or sunroof 106 is configured with a region 110 delimited towards the rear by a border symbolized as a dotted line for example in the direction of travel of the motor vehicle 100, which has a so-called touch screen function, i.e. is configured as a touch screen via which various devices, assemblies and functions of the motor vehicle 100 can be controlled. Optionally the virtual panoramic roof or sunroof can also be configured at least approximately along its entire extension as a touch screen. For example, spotlights and/or reading lamps 122 and movable sun visors 112 which can at least partially replace the previously described fold-down sun visors 111 are provided and can be operated via the touch screen 110. As a result of this design of the sun visors 112 and a substantially punctuate design of the spotlights and/or reading lamps 122, the region behind the windscreen 108 is kept free for the touch screen 110.

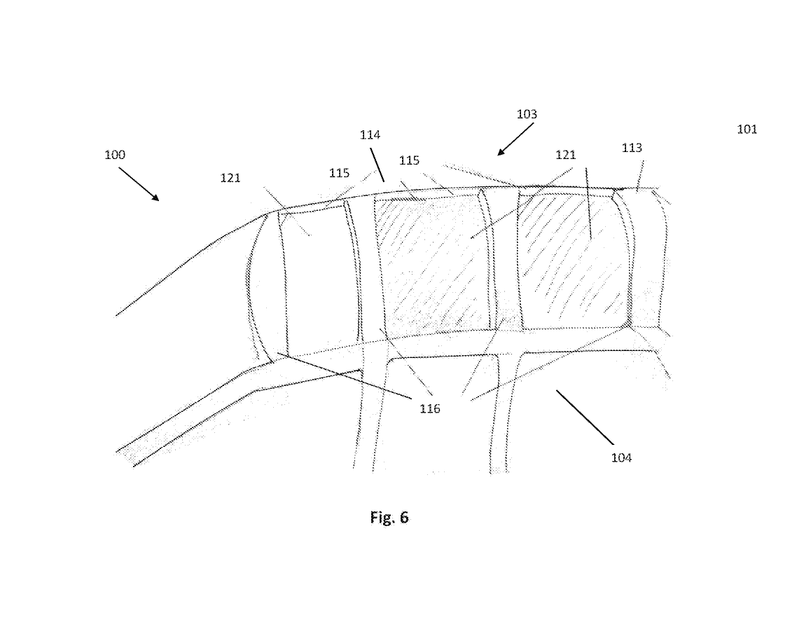

FIG. 6 shows a perspective view of a vehicle body 113 of a motor vehicle 100, in particular of a vehicle roof 101 of the motor vehicle 100 or the vehicle body 113. Here the vehicle roof 101 at the same time forms a base element or trough element 114 of a roof box 103 which is integrated in the vehicle roof 101 and/or foldable, as indicated in FIG. 2. The vehicle roof 101 is formed with transverse pillars 116, here in particular with A, B, C and D transverse pillars 116. Between each two adjacent ones of the transverse pillars 116 the vehicle roof 101 is formed with recesses 115 by means of which a volume of the roof box 103 is expanded downwards, i.e. towards the roof liner 105 or towards the vehicle interior 104. The space, i.e. storage space of the roof box 103 can thus be better used. Preferably damping elements 121, in particular mat-shaped damping elements 121, are arranged in the recesses 115, i.e. inserted therein. These damping elements 121 are used both as sound damping and as cushioning or impact protection for items carried in the roof box.

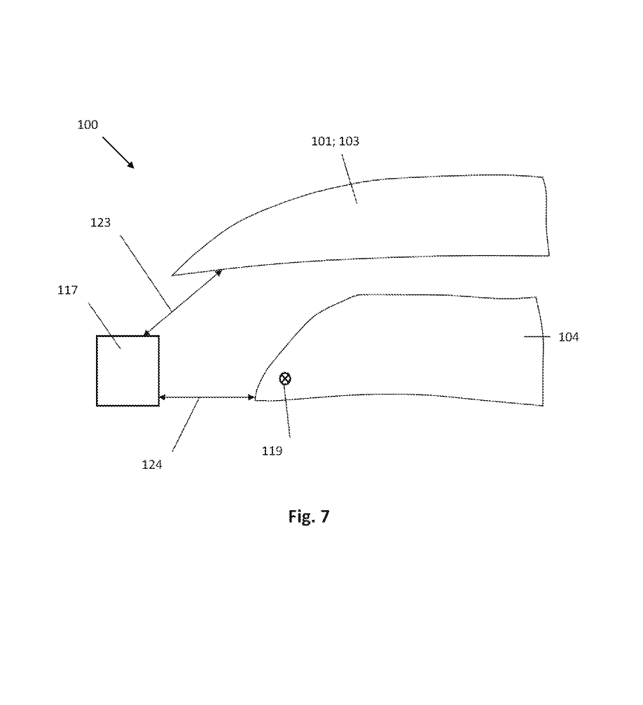

FIG. 7 shows a schematic diagram for signal exchange between the sensors 102 of the roof box 103 or the vehicle roof 101, an on-board computer 117 as well as other sensors and/or reproduction devices, also designated as terminals and applications, in the vehicles interior 104. For example, a microphone 119 in the vehicle interior 104 is indicated for the further sensors. The sensors 102 of the roof box 103 or the vehicle roof 101 are connected to the on-board computer 117 via a first signal connection 123 for supplying sensor signals to the on-board computer 117. The on-board computer 117 is connected to further sensors 119 and/or reproduction devices in the vehicle interior 104 via a second signal connection 124 for supplying sensor signals of the further sensors 119 to the on-board computer 117 and/or for supplying reproduction signals from the on-board computer 117 to the reproduction devices in the vehicle interior 104. In the on-board computer 117 the sensor signals are converted into reproduction signals.

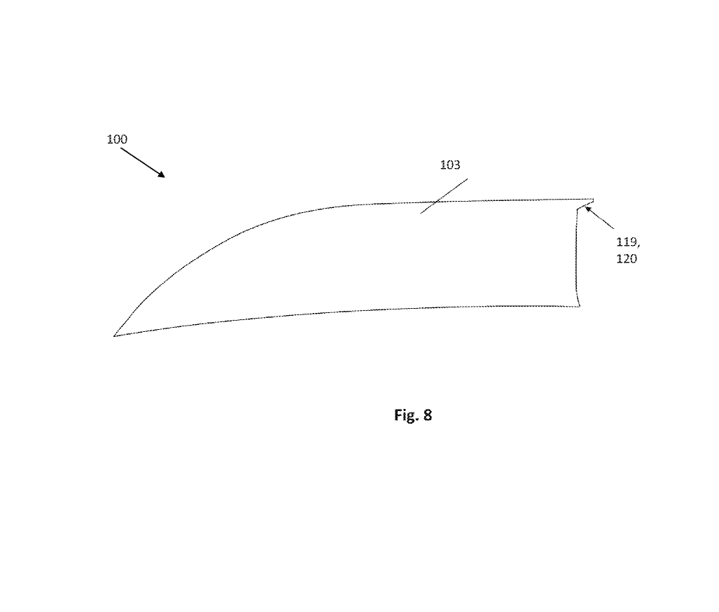

FIG. 8 shows a diagram of a roof box 103 with an exemplary embodiment for an application of at least one microphone 119 and at least one loudspeaker 120, here however provided for a sound recording in a surroundings, preferably an immediate surroundings of the motor vehicle 100 or for an audio recording in the surroundings, preferably the immediate surroundings of the motor vehicle 100. Particularly preferably the at least one microphone 119 and/or the at least one loudspeaker 120 are arranged in a rear region of the roof box 103, in particular on its rear wall, and thus protected particularly well against in particular airflow and/or weather influences.

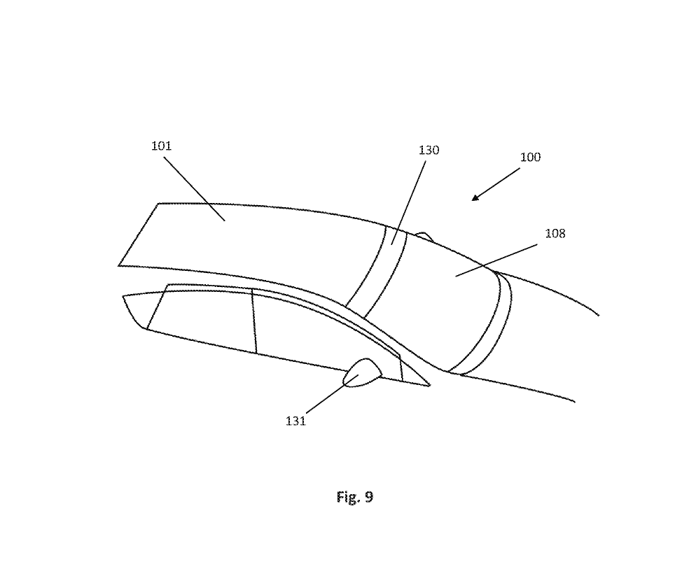

FIG. 9 shows a perspective view of another exemplary embodiment of a vehicle roof 101 fitted with a windscreen 108 which is configured in an upper region 130 adjoining the vehicle roof 101 with at least one reproduction device, in particular image reproduction device, in another front view obliquely upwards on the outside. In this example, the region 130 has at least one reproduction device, in particular image reproduction device, both on an inner face facing the vehicle interior 104 of the vehicle 100 and on an outer face of the windscreen 108 facing the surroundings. The region 130 is configured both with a sun visor function and also with display functions, wherein information can be reproduced both for the user, in particular the driver, towards the interior and also for other road users in the surroundings outwards. As an example, mention is made of a display of a navigation system or a reproduction of a reversing or rear mirror camera which here replaces an inner rear mirror of conventional design for a display in the vehicle interior 104. In this exemplary embodiment, conventional outer rear mirrors 131 are also provided but in a further development these can be replaced by a reproduction on the inner face of the windscreen 108 in the region 130. As an example for a reproduction on the outer face of the windscreen 108, possibly a taxi sign, a vignette, a parking disk or an emissions or pollution badge can be displayed in the region 130.

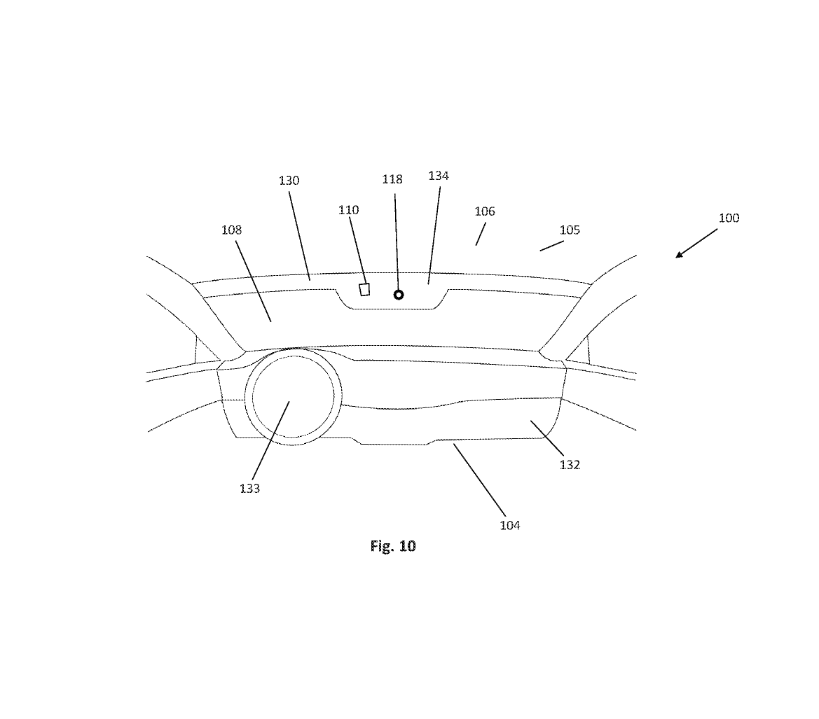

FIG. 10 shows a perspective view of the vehicle interior 104 of the exemplary embodiment according to FIG. 9 with a view in the direction of travel of the dashboard 132 with the steering wheel 133 and the windscreen 108 configured in the region 130 with at least one reproduction device, in particular image reproduction device. Preferably operating elements, in particular touch operating elements with a touch screen function 110, and/or sensors, e.g. a face recognition sensor 118 are disposed in a subregion 134 on the inner face of the windscreen 108 within the region 130. These sensors 118 are for example configured as cameras and adapted to record a movement and/or gesture, preferably a head movement, head position or viewing direction of the eyes, of the driver and control the image reproduction of the reversing or rear mirror camera according to this, in particular the size of this image reproduction.

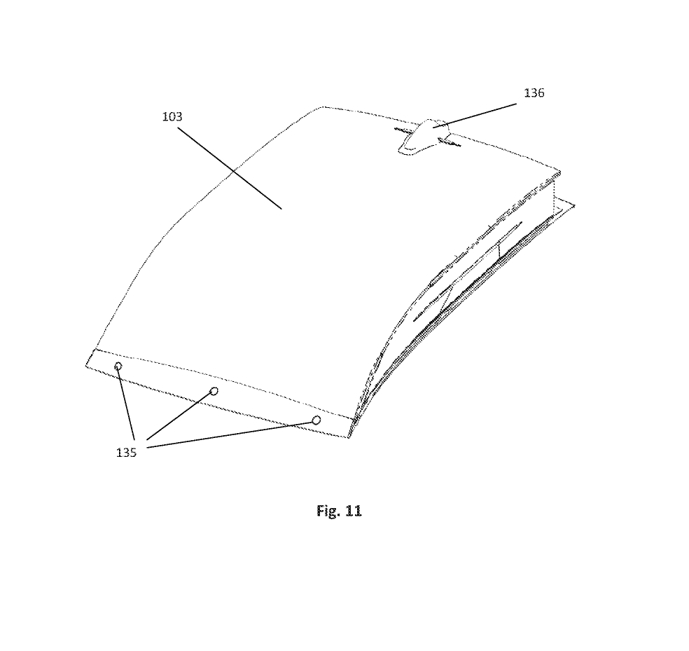

FIG. 11 shows a perspective view of an exemplary embodiment for a roof box 103 fitted with a plurality of height sensors 135 according to the invention for a motor vehicle 100 according one of the preceding exemplary embodiments. The roof box is reproduced in the folded-out state. Three of the height sensors 135 are attached to the front edge of the lid of the roof box 103. Furthermore, a receiving housing 136 is attached at the rear edge of the lid of the roof box 103, i.e. at the highest point of the motor vehicle 100 fitted therewith. Apart from at least one of the height sensors 135, preferably recognition means for independent driving are disposed in the receiving housing 136, e.g. laser scanners, optical sensors of special design, ultrasound sensors, radar sensors or the like.

In a preferred example the height sensors 135 are configured in the manner of proximity sensors but can for example also be provided with one or more cameras. The height sensors 135 or the height sensors 135 detect an approach of the motor vehicle 100, in particular the lid of the roof box 103, to an obstacle which limits a travel section of the motor vehicle 100 in terms of height and for example gives a warning signal to the driver. More comprehensive information, e.g. camera images of the obstacle can also be produced and transmitted.

The vehicle roof 101 of a motor vehicle 100 can be fitted directly with height sensors 135 if no roof box 103 is mounted. If a roof box 103 is mounted subsequently, i.e. retrofitted, sensors arranged advantageously on the roof box 103, in particular height sensors 135, are connected to the on-board computer 117 additionally to or instead of the sensors on the vehicle roof 101.

### REFERENCE LIST

100 Motor vehicle
101 Vehicle roof

### 102 Sensors

103 Roof box, in particular integrable and/or foldable
104 Vehicle interior
105 Roof liner
106 Virtual panoramic roof or sunroof
107 Folded-down part of the monitor/display

### 108 Windscreen

109 Operating elements on the roof liner 105
110 Touch screen function
111 Fold-down sun visors
112 Movable sun visors and/or air outlets
113 Vehicle body
114 Base/trough element of roof box 103

### 115 Recesses

116 Transverse pillars
117 On-board computer
118 Face recognition sensor on 105

### 119 Microphone

### 120 Loudspeaker

121 Damping elements
122 Reading lamps and/or tanning lamps
123 First signal connection
124 Second signal connection
130 Region of 108 with sun visor and display function
131 Outside rear mirror of conventional design

### 132 Dashboard

133 Steering wheel
134 Subregion of 130 on inner face f 108
135 Height sensor on lid of 103
136 Receiving housing for 135, aerials inter alia

1. An assembly for a roof of a motor vehicle, comprising:
at least one sensor device for recording the surroundings of the motor vehicle; and
at least one reproduction device disposed on an inner face of the roof for reproducing a virtual representation of at least the surroundings captured by the at least one sensor device at least approximately equal to at least one of a perception or a view of at least the surroundings through a sunroof or panoramic roof.

2. The assembly according to claim 1,
wherein
at least one of the at least one sensor device or the at least one reproduction device is configured to be adjustable by the user.

3. The assembly according to claim 1,
wherein
the roof further comprises a roof box and that at least one of the at least one sensor device is disposed on the roof box.

4. The assembly according to claim 1,
wherein
the at least one reproduction device is arranged to extend at least on a roof liner forming an inner face of the roof.

5. The assembly according to claim 1,
wherein
at least an upper region of at least a windscreen on at least one of its inner or outer face with at least one reproduction device is configured to at least one of
reproduce a virtual representation of at least one section of the surroundings towards the interior of the motor vehicle,
reproduce a virtual representation of at least one subregion of the interior towards at least one of the interior or the surroundings of the motor vehicle or
reproduce at least one virtual representation of at least one item of information of a vehicle display instrument towards the interior of the motor vehicle or
reproduce at least one virtual representation of at least one item of information towards the surroundings of the motor vehicle or
at least partially dimming a transparency of the at least one upper region of at least the windscreen to form a sunscreen,
wherein for controlling the preceding reproductions, at least one sensor signal of
at least one sensor for recording a direction of incidence of the sunlight or
of at least one sensor for recording at least one of a movement or gesture or viewing direction of at least one user of the motor vehicle,
is used at least in the manner
that the at least partial dimming of the transparency of the at least upper region of at least the windscreen is undertaken to form the sunscreen depending on the direction of incidence of the sunlight or
that the optional reproduction of the virtual representation of the at least one section of the surroundings or of the at least one subregion of the interior is undertaken depending on at least one of the movement or gesture or viewing direction of the at least one user of the motor vehicle.

6. The assembly according to claim 1,
wherein
the at least one reproduction device further comprises a touch screen for controlling at least one of the reproduction of the virtual representation of the surroundings or further devices of an interior of the motor vehicle.

7. The assembly according to claim 1,
wherein
the at least one reproduction device further comprises at least two partial reproduction devices of which at least one front one is disposed at least predominantly in a front region of the roof and at least one rear one is disposed at least predominantly in a rear region of the roof.

8. The assembly according to claim 1, for a roof of a motor vehicle with a roof box which has a base element or a trough element or a trough-like base element,
wherein
the base element or trough element or trough-like base element has at least one recess between transverse pillars of the roof.

9. The assembly according to claim 8,
wherein
the base element or trough element or trough-like base element is configured with at least one damping element.

10. The assembly according to claim 8,
wherein
the at least one reproduction device is disposed in the position of the sunroof or panoramic roof and at least partially in the region underneath the at least one recess of the base element or trough element or trough-like base element.

11. The assembly according to claim 1,
wherein the sensor device is an image-capture device for the pictorial recording of at least the surroundings of the motor vehicle.

12. The assembly according to claim 1,
wherein the reproduction device is an image reproduction device for reproducing a virtual pictorial representation of at least the surroundings of the motor vehicle.

13. The assembly according to claim 1,
wherein the least one reproduction device is disposed in a position of a sunroof or panoramic roof.

14. The assembly according to claim 3,
wherein
the roof box is one of a foldable or integrable roof box, and that at least one of the at least one sensor device is disposed at or on a lid of the roof box.

15. The assembly according to claim 4,
wherein
the at least one reproduction device is arranged to extend at least one of at least approximately as far as a windscreen or front window of the motor vehicle or at least over a subregion of at least the windscreen.

16. The assembly according to claim 7,
wherein
a spatial position of at least one of the partial reproduction devices is adjustable or controllable.

17. The assembly according to claim 16,
wherein
that the at least one rear partial reproduction device is foldable or rotatable.

18. The assembly according to claim 17,
wherein
that the at least one rear partial reproduction device is capable of being folded down.

19. The assembly according to claim 9,
wherein
the at least one damping element is at least one damping mat.

20. The assembly according to claim 9,
wherein
the at least one damping element is disposed in the at least one recess.
